(19) United States
(12) Patent Application Publication
(10) Pub. No.: US 2008/0001839 A1
(43) Pub. Date: Jan. 3, 2008

(54) Multi-frequency antenna and related mobile device

(75) Inventors: Shen-Pin Wei, Taipei Hsien (TW); Chia-Tien Li, Taipei Hsien (TW)

Correspondence Address: BACON & THOMAS, PLLC, 625 SLATERS LANE, FOURTH FLOOR, ALEXANDRIA, VA, 22314, US

(73) Assignee: WISTRON NEWEB CORP., Taipei Hsien (TW)

(21) Appl. No.: 11/724,182

(22) Filed: Mar. 15, 2007

(30) Foreign Application Priority Data
Jun. 30, 2006 (TW) 095123987

(51) Int. Cl. H01Q 1/48

(52) U.S. Cl. 343/848

(57) ABSTRACT

A multi-frequency antenna is disclosed. The multi-frequency antenna is positioned on a mobile device for transmitting wireless signals. The multi-frequency antenna comprises a radiating element, a grounding element and a connecting element. The connecting element is connected to the radiating element and the grounding element. The grounding element has a substantially U-shape structure so that it is capable of clipping with an edge of the mobile device.

### BACKGROUND OF THE INVENTION

1. Field of the Invention

The present invention relates an antenna, and, more particularly, to a multi-frequency antenna for a wireless communication system.

2. Description of the Related Art

With the wireless communication technology development, there are many electronic products with wireless communication function on the market, for example, mobile phones and notebook computers all utilize wireless communication technology to transmit data. The above-mentioned electronic devices all have antennas to complete the wireless communication function.

Please refer to FIG. 1A. FIG. 1A shows a prior art technology disclosed in U.S. Pat. No. 6,861,986. An antenna 90 comprises a radiating element 91, a connecting element 92 and a grounding element 93. The connecting element 92 has a first end 921 and a second end 922. Furthermore, the first end 921 of the connecting element 92 is connected to the radiating element 91, and the second end 922 is connected to the grounding element 93.

Next, please refer to FIG. 1B. FIG. 1B shows different efficiencies of the prior art antenna 90 shown in FIG. 1A at different frequencies. As shown in FIG. 1B, the prior art antenna 90 has an efficiency about 50% at low frequencies 2.4 GHz˜2.5 GHz and has an efficiency about only 30% at high frequencies 5.15 GHz˜5.85 GHz.

Moreover, the prior art antenna 90 has a larger volume. If the prior art antenna 90 is installed in a notebook computer, the notebook computer needs to provide relative larger volume. In addition, the prior art antenna 90 usually requires screws to be fastened on the notebook computer, which increases manufacturing cost.

It is therefore desirable to provide a multi-frequency antenna which has a reduced volume, a higher efficiency, and a lower manufacturing cost to obviate the aforementioned problems.

### SUMMARY OF THE INVENTION

In order to achieve the above mentioned objectives, the present invention provides a multi-frequency antenna and a related mobile device.

The multi-frequency antenna of the present invention comprises a radiating element, a grounding element and a connecting element. The connecting element comprises a first end and a second end; the grounding element comprises a first plane, a second plane and a third plane. The third plane separately and perpendicularly adjoin the first plane and the second plane so the grounding element substantially has a U-shape structure.

In an embodiment of the present invention, the first plane further has a first U-shaped portion and a second U-shaped portion, which are both perpendicular to the first plane, and the radiating element has at least one flute. The first end of the connecting element is connected to the radiating element and the second end of the connecting element is connected to the first plane; the first end and the radiating element perpendicularly adjoin each other, and the second end and the first plane perpendicularly adjoin each other.

Moreover, in one embodiment, the multi-frequency antenna further comprises an opening for the multi-frequency antenna to be hanged on a frame of the mobile device, and the first plane of the multi-frequency antenna with a plurality of concaves can be fastened with the frame of the mobile device with a plurality of corresponding connecting areas.

Other objects, advantages, and novel features of the invention will become more apparent from the following detailed description when taken in conjunction with the accompanying drawings.

### BRIEF DESCRIPTION OF THE DRAWINGS

FIG. 1A is a structural drawing of a prior art antenna.

FIG. 1B shows different efficiencies of the prior art antenna shown in FIG. 1A at different frequencies.

FIG. 2A is a perspective drawing of a multi-frequency antenna of an embodiment of the present invention.

FIG. 2B is a front view drawing of the multi-frequency antenna shown in FIG. 2A.

FIG. 2C shows different efficiencies of the multi-frequency antenna shown in FIG. 2A at different frequencies.

FIG. 3 is a schematic drawing showing the multi-frequency antenna being installed on the mobile device.

FIG. 4A is a schematic drawing showing a combination of the multi-frequency antenna and a frame.

FIG. 4B is a perspective drawing of the combination of the multi-frequency antenna and the frame shown in FIG. 4A.

FIG. 4C is a front view drawing of the combination of the multi-frequency antenna and the frame shown in FIG. 4A.

FIG. 5 is a system functional block drawing of the mobile device of the present invention.

### DETAILED DESCRIPTION OF THE PREFERRED EMBODIMENT

Following description provides an embodiment of a multi-frequency antenna and an embodiment of the multi-frequency antenna being installed in a mobile device with related drawings.

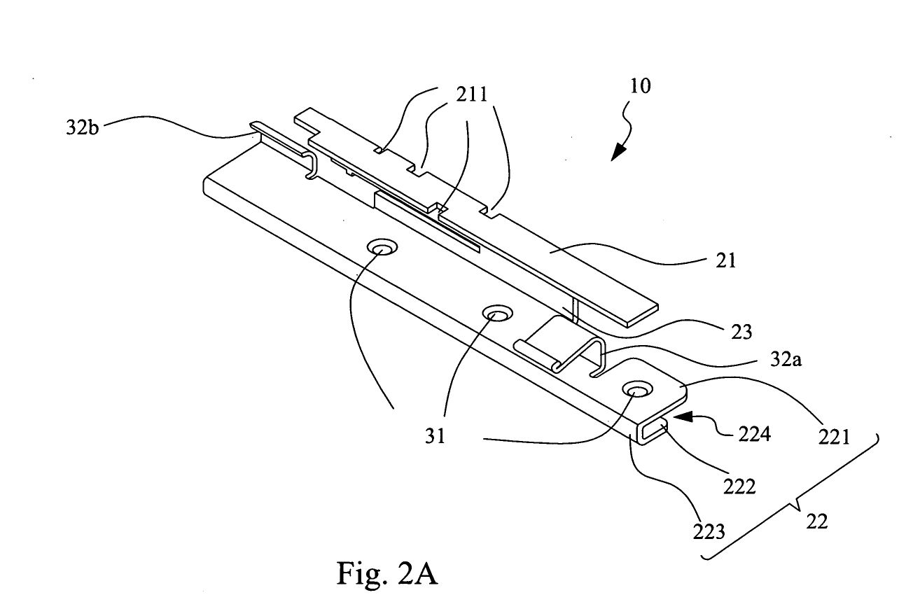

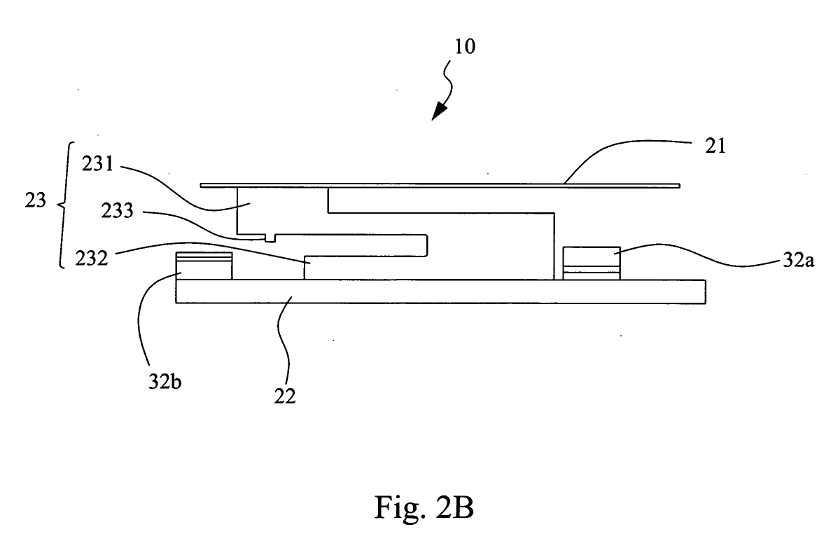

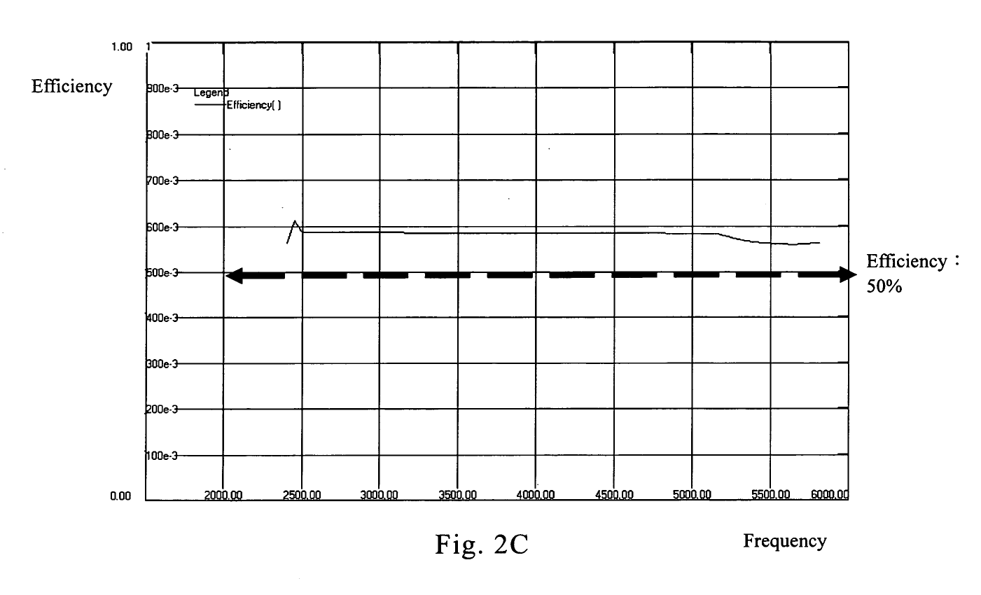

Please refer to FIG. 2A and FIG. 2B. FIG. 2A is a perspective drawing of a multi-frequency antenna of an embodiment of the present invention. FIG. 2B is a front view drawing of the multi-frequency antenna shown in FIG. 2A.

As shown in FIG. 2 and FIG. 2B, a multi-frequency antenna 10 comprises a radiating element 21, a grounding element 22 and a connecting element 23. The connecting element 23 comprises a first end 231 and a second end 232. The grounding element 22 comprises a first plane 221, a second plane 222 and a third plane 223, and the third plane 223 separately and perpendicularly adjoins the first plane 221 and the second plane 222 so the grounding element 22 substantially has a U-shape structure. The radiating element 21 may be a metal plate with a long stripe shape, when the currents are feeding, the radiating element 21 excite the radiation energy via the currents.

As shown in FIG. 2A and FIG. 2B, the first end 231 of the connecting element 23 is electrically connected to the radiating element 21, and the second end 232 of the connecting element 23 is electrically connected to the first plane 221 of the grounding element 22. Furthermore, the first end 231 and the radiating element 21 perpendicularly adjoin each other; the second end 232 and the first plane 221 also perpendicularly adjoin each other, so the multi-frequency antenna 10 forms a three-dimensional structure to reduce its volume. The connecting element 23 comprises a feeding point 233, which is slightly protruded from the first end 231 of the connecting element 23. With the feeding point 233, a feeding wire (not shown) is electrically connected to the feeding point 233 for feeding currents, and the radiating element 21 can excite the radiation energy via the currents, for example, receiving or transmitting wireless signals with 2.4 GHz and 5 GHz frequencies.

In one embodiment of the present invention, the radiating element 21 has at least one flute 211 for increasing its radiation efficiency. For example, the flute 211 can be disposed on the edge of the radiating element 21. Moreover, flute 211 disposed on the radiating element 21 is used for changing the current distribution on the radiating element 21 and further for increasing inductance to enhance the radiation efficiency of the multi-frequency antenna 10. Furthermore, the present invention utilizes the width of the radiating element 21 to increase the frequency band of the multi-frequency antenna 10. In addition, the multi-frequency antenna 10 can be made of metal with good electric conductivity, such as copper alloy.

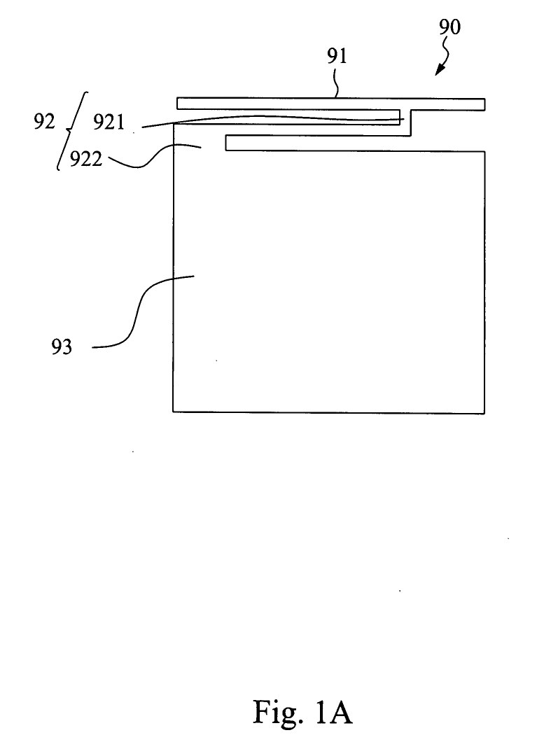

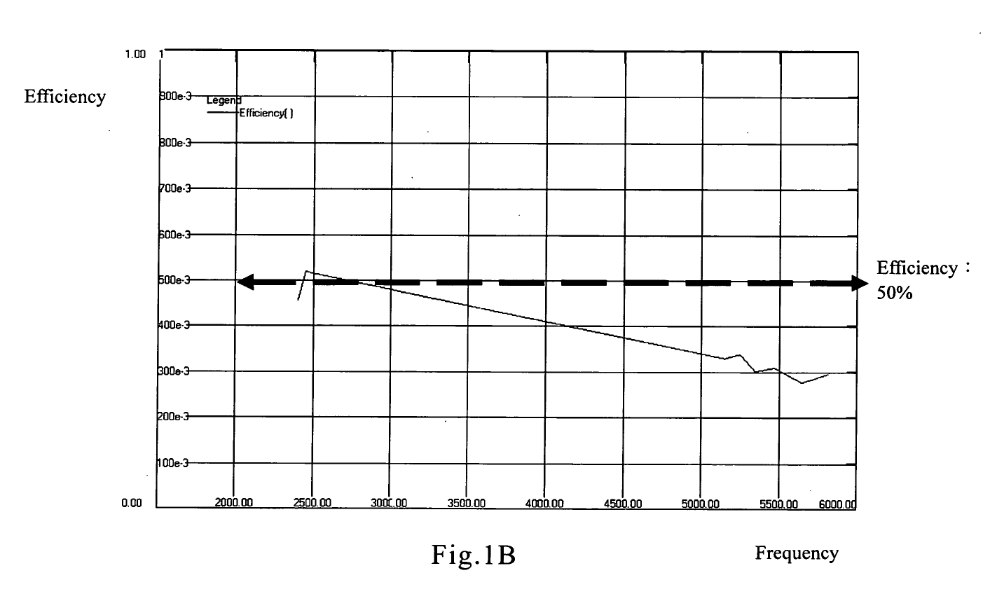

Please refer to FIG. 2C. FIG. 2C shows different efficiencies of the multi-frequency antenna 10 shown in FIG. 2A at different frequencies. According to FIG. 2C, the multi-frequency antenna 10 has an efficiency about 60% at low frequencies 2.4 GHz˜2.5 GHz and has an efficiency about 55% at high frequencies 5.15 GHz˜5.85 GHz. Comparing with the prior art antenna 90 shown in FIG. 1B, the efficiency of the multi-frequency antenna 10 is much higher than the efficiency of the multi-frequency antenna 90.

In addition, on the multi-frequency antenna 10, a first U-shaped portion 32a and a second U-shaped portion 32b can be perpendicularly disposed on the first plane 221 and used for fixing the feeding wire or other cables or other purposes.

Furthermore, the U-shaped structure of the grounding element 22 can have an opening 224, and the opening 224 can be used for enabling the multi-frequency antenna 10 to be hanged on the frame of the mobile device. Moreover, the first plane 221 comprises a plurality of concaves 31, and the plurality of concaves 31 can help the multi-frequency antenna 10 to be fastened on the mobile device (another following embodiment will provide more detail).

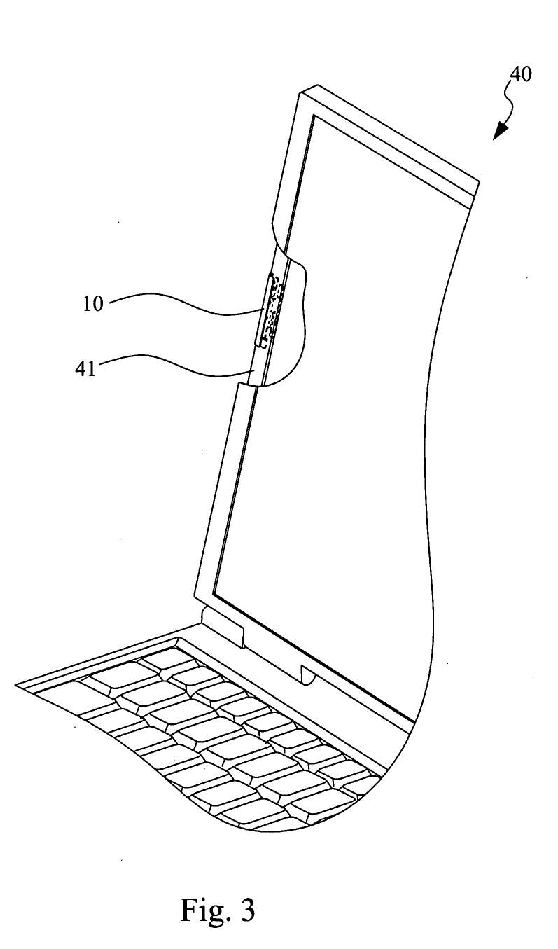

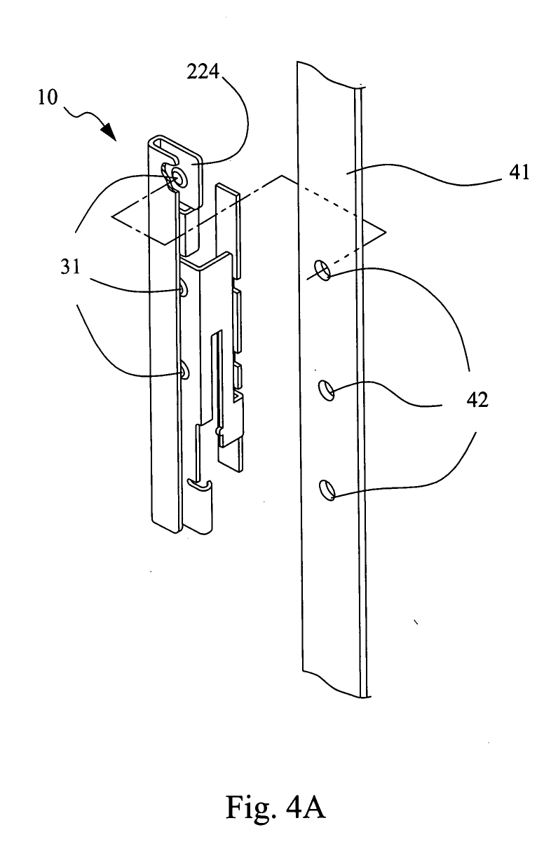

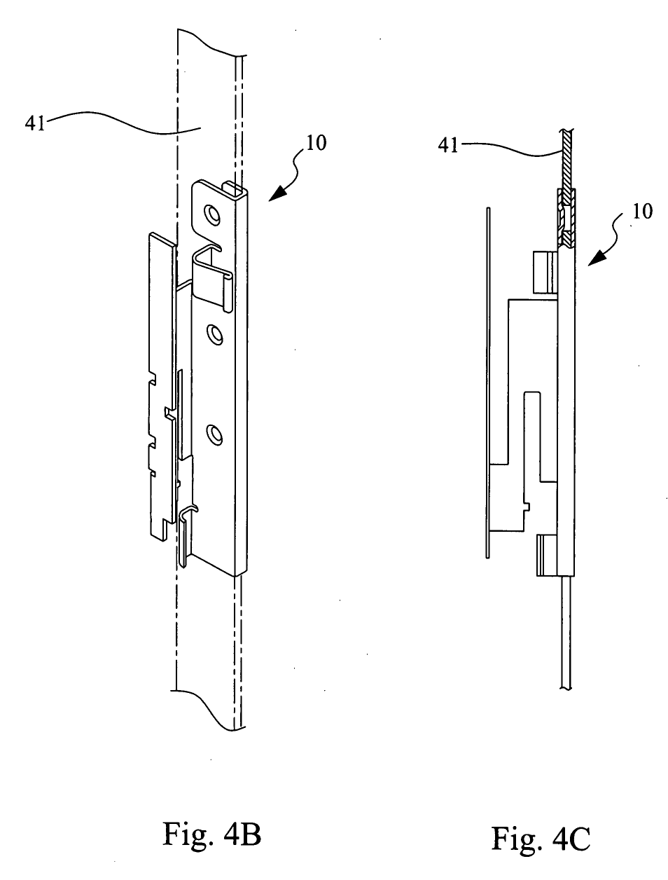

The present invention also provides a mobile device with the multi-frequency antenna 10, for transmitting and receiving wireless signals. Please refer to FIG. 3, FIG. 4A to FIG. 4C.

In the following embodiment, a mobile device 40 is a notebook computer; however, the mobile device 40 can also be a mobile phone or a personal digital assistant (PDA), or other similar device.

As shown in FIG. 3, the mobile device 40 comprises a frame 41, and the multi-frequency antenna 10 is installed on the frame 41 of the mobile device 40. The multi-frequency antenna 10 can be installed at different position on the frame 41.

FIG. 4A is a schematic drawing showing a combination of the multi-frequency antenna and a frame. As shown in FIG. 4A (please also refer FIG. 2A), the multi-frequency antenna 10 is fixed on the frame 41 via the grounding element 22. Since the first plane 221, the second plane 222 and the third plane 223 of the grounding element 22 forms a U-shaped structure, and the U-shaped structure has the opening 224, the frame 41 can be inserted in the opening 224 to hang the multi-frequency antenna 10 on the frame 41. Furthermore, the first plane 221 has a plurality of concaves 31, and the frame 41 has a plurality of corresponding connecting areas 42, so the first plane 221 of the multi-frequency antenna 10 can be fastened with the frame 41 of the mobile device 40. FIG. 4B is a perspective drawing of the combination of the multi-frequency antenna and the frame shown in FIG. 4A. FIG. 4C is a front view drawing of the combination of the multi-frequency antenna and the frame shown in FIG. 4A. With the above mentioned mechanism, the present invention needs no screws or other fastening elements, which can reduce manufacturing cost.

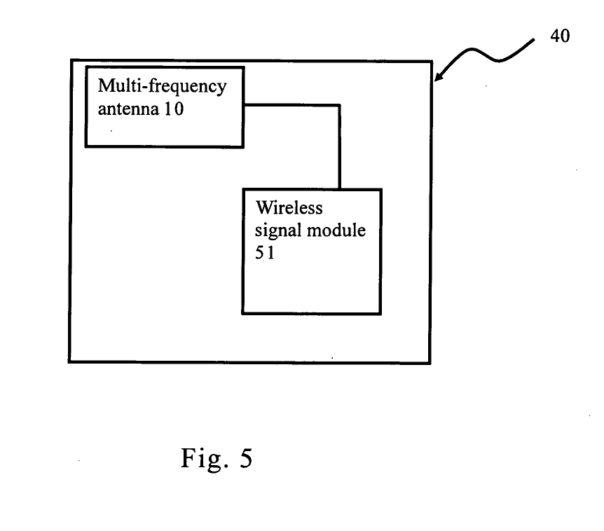

Finally, please refer to FIG. 5. FIG. 5 is a system functional block drawing of the mobile device of the present invention. As shown in FIG. 5, when the multi-frequency antenna 10 is installed on the frame 41, a feeding wire is electrically connected to the multi-frequency antenna 10 (for example, for feeding currents to the feeding point 233) and a wireless signal module 51, to utilize the wireless signal module 51 to process signals from the multi-frequency antenna 10. Therefore, the mobile device 40 can receive or transmit wireless signals via the multi-frequency antenna 10 (not shown) to achieve wireless communication.

Although the present invention has been explained in relation to its preferred embodiment, it is to be understood that many other possible modifications and variations can be made without departing from the spirit and scope of the invention as hereinafter claimed.

What is claimed is:

1. A multi-frequency antenna comprising:
a radiating element;
a grounding element comprising a first plane, a second plane and a third plane, the third plane being separately and perpendicularly adjoined the first plane and the second plane so the grounding element substantially having a U-shape structure; and
a connecting element comprising a first end and a second end, the first end being connected to the radiating element and the second end being connected to the first plane.

2. The multi-frequency antenna as claimed in claim 1, wherein the multi-frequency antenna is able to disposed on a frame of a mobile device and the grounding element further comprises an opening for the multi-frequency antenna to be hanged on the frame of the mobile device.

3. The multi-frequency antenna as claimed in claim 2, wherein the mobile device is a notebook computer, a mobile phone or a personal digital assistant (PDA).

4. The multi-frequency antenna as claimed in claim 1, wherein the radiating element comprises at least one flute.

5. The multi-frequency antenna as claimed in claim 1, wherein the first plane further comprises a plurality of concaves.

6. The multi-frequency antenna as claimed in claim 1 further comprising a U-shaped portion, the U-shaped portion perpendicularly extended from the first plane.

7. The multi-frequency antenna as claimed in claim 1, wherein the radiating element and the first end of the connecting element perpendicularly adjoin each other.

8. The multi-frequency antenna as claimed in claim 1, wherein the first plane and the second end of the connecting element perpendicularly adjoin each other.

9. The multi-frequency antenna as claimed in claim 1, wherein the connecting element further comprises a feeding point, the feeding point is slightly protruded from the first end of the connecting element.

10. A mobile device for transmitting and receiving wireless signals, the mobile device comprising:
a wireless signal module; and
a multi-frequency antenna electrically connected to the wireless signal module, the multi-frequency antenna comprising:
a radiating element;
a grounding element comprising a first plane a second plane and a third plane, the third plane being separately and perpendicularly adjoined the first plane and the second plane so the grounding element substantially having a U-shape structure; and
a connecting element comprising a first end and a second end, the first end being connected to the radiating element and the second end being connected to the first plane.

11. The mobile device as claimed in claim 10 further comprising a frame, and the grounding element having an opening for the multi-frequency antenna to hang on the frame of the mobile device.

12. The mobile device as claimed in claim 11, wherein the mobile device is a notebook computer, a mobile phone or a personal digital assistant (PDA).

13. The mobile device as claimed in claim 11, wherein the first plane further comprises a plurality of concaves, and the frame further comprises a plurality of connecting areas for being assembled on the concaves.

14. The mobile device as claimed in claim 10, wherein the radiating element comprises at least one flute.

15. The mobile device as claimed in claim 10 further comprising at least one U-shaped portion, the U-shaped portion perpendicularly extended from the first plane.

16. The mobile device as claimed in claim 10, wherein the radiating element and the first end of the connecting element perpendicularly adjoin each other.

17. The mobile device as claimed in claim 10, wherein the radiating element and the second end of the connecting element perpendicularly adjoin each other.

18. The mobile device as claimed in claim 10, wherein the connecting element further comprises a feeding point, the feeding point is slightly protruded from the first end of the connecting element.
